(19) United States
(12) Patent Application Publication
(10) Pub. No.: US 2013/0050266 A1
(43) Pub. Date: Feb. 28, 2013

(54) DISPLAY INTERFACE ADJUSTING METHOD AND SYSTEM

(71) Applicants: Kin Ping NG, Hong Kong (CN); Siu Man YU, Hong Kong (CN)

(72) Inventors: Kin Ping NG, Hong Kong (CN); Siu Man YU, Hong Kong (CN)

(73) Assignee: PERCEPTION DIGITAL LIMITED, Hong Kong (CN)

(21) Appl. No.: 13/345,523

(22) Filed: Jan. 6, 2012

(30) Foreign Application Priority Data
Aug. 25, 2011 (CN) 201110246615.9

(51) Int. Cl. G09G 5/373

(52) U.S. Cl. 345/660

(57) ABSTRACT

A method and a system for adjusting a display interface are disclosed. The method includes setting a control region on a display screen; identifying operating commands to the control region and acquiring an aspect ratio of the display screen according to the operating commands; and adjusting the display interface according to the aspect ratio of the display screen. The system includes a setting module used for setting a control region on the display screen; an information acquiring module used for identifying operating commands to the control region and acquiring an aspect ratio of the display screen according to the operating commands; and an interface adjusting module used for adjusting a display interface according to the aspect ratio of said display screen.

### FIELD OF THE INVENTION

The present invention generally relates to display technology, and more particularly, to a display interface adjusting method and a display interface adjusting system.

### BACKGROUND

With the development of the digital technology, more and more TV functions are exploited for latest multimedia apparatuses, for example transmitting and outputting signals to an external display device. The TV output signal has a predetermined size, however sometimes the predetermined size is different from the size of a screen of the display device. For example, if the predetermined size of the TV output signal is larger than that of the display area of the screen, a part of the TV output signal cannot be displayed; or if the predetermined size of the TV output signal is smaller than that of the display area, the actual displayed image would just occupy a part of the display area with another part displaying nothing, which will make the watching uncomfortable. A present solution provides buttons on the display screen for users to adjust the size of the display interface of the TV output signal manually. However, this is not convenient.

The disclosed method and system are directed to solve one or more problems set forth above and other relevant problems.

### BRIEF SUMMARY OF THE DISCLOSURE

One aspect of the present disclosure includes a method for adjusting a display interface. The method includes setting a control region on a display screen; identifying operating commands to the control region and acquiring an aspect ratio of the display screen according to the operating commands; and adjusting the display interface according to the aspect ratio of the display screen. Wherein the step of setting said control region on the display screen includes said control region can be set at arbitrary positions of the display screen. The step of setting said control region on the display screen includes acquiring a display location of the display interface displayed on the display screen; and displaying the control region on the display interface according to the display location. The step of identifying the operating commands to the control region includes identifying a first click command to the control region; and the step of adjusting the display interface according to the aspect ratio of the display screen includes acquiring the aspect ratio of the display screen according to the first click command and adjusting the display interface according to the aspect ratio of the display screen. The step of identifying the operating commands to the control region further includes determining whether a second click command is acquired, and if the second click command is acquired, then a first position corresponding to the first click and a second position corresponding to the second click will be acquired respectively; acquiring an aspect ratio of a user selected region according to the first position and the second position; and adjusting the display interface according to the aspect ratio of the user selected region.

Another aspect of the present disclosure includes a system for adjusting a display interface. The system includes a setting module used for setting a control region on a display screen; an information acquiring module used for identifying operating commands to the control region and acquiring an aspect ratio of the display screen according to the operating commands; and an interface adjusting module used for adjusting a display interface according to the aspect ratio of said display screen. Wherein said setting module is further used for setting said control region on arbitrary positions of the display screen. The information acquiring module is further used for acquiring a display location of the display interface displayed on the display screen; and the setting module is further used for displaying the control region on the display interface according to the display location. The information acquiring module is further used for identifying a first click command to the control region and acquiring an aspect ratio of the display screen according to the first click command. The system further includes a determining module used for determining whether a second click command is acquired after the first click command to the control region is acquired by said information acquiring module; and if the information acquiring module acquires the second click command, the information acquiring module will acquire a first position and a second position according to the first click command and the second click command respectively, and then further acquire an aspect ratio of a user selected region according to the first position and the second position; the display interface is adjusted by said interface adjusting module according to the aspect ratio of the user selected region.

Other aspects of the present disclosure can be understood by those skilled in the art in light of the description, the claims, and the drawings of the present disclosure.

### BRIEF DESCRIPTION OF THE DRAWINGS

FIG. 1 shows a flow chart of a method for adjusting the display interface according to an embodiment;

FIG. 2 shows a first schematic diagram of setting a control region of FIG. 1;

FIG. 3 shows a second schematic diagram of setting the control region of FIG. 1;

FIG. 4 shows a third schematic diagram of setting the control region of FIG. 1;

FIG. 5 shows a flow chart of the method for adjusting the display interface according to another embodiment;

FIG. 6 shows a first schematic diagram of setting the control region of FIG. 5;

FIG. 7 shows a second schematic diagram of setting the control region of FIG. 5;

FIG. 8 shows a third schematic diagram of setting the control region of FIG. 5;

FIG. 9 shows a schematic structural diagram of a system for adjusting the display interface according to an embodiment; and

FIG. 10 shows a schematic structural diagram of the system for adjusting the display interface according to another embodiment.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

Referring to FIG. 1, the method for adjusting a display interface in accordance with an embodiment includes the following steps.

In step S110, a control region is set on a display screen.

In an embodiment, the control region can be set at arbitrary positions on the display screen. An aspect ratio of the control region is determined according to an aspect ratio of the display screen. Preferably, the control region is displayed at the top left corner of the display interface on the display screen.

In an embodiment, the step 110 further includes a step to acquire a display location of the display interface displayed on the display screen and display the control region based on the display location.

In step S120, operating commands for the control region are identified, and the aspect ratio of the display screen is acquired according to the operating commands.

In an embodiment, a first click command for the control region is identified and the aspect ratio of the display screen is acquired according to the first click command. The display interface is adjusted according to the aspect ratio of the display screen.

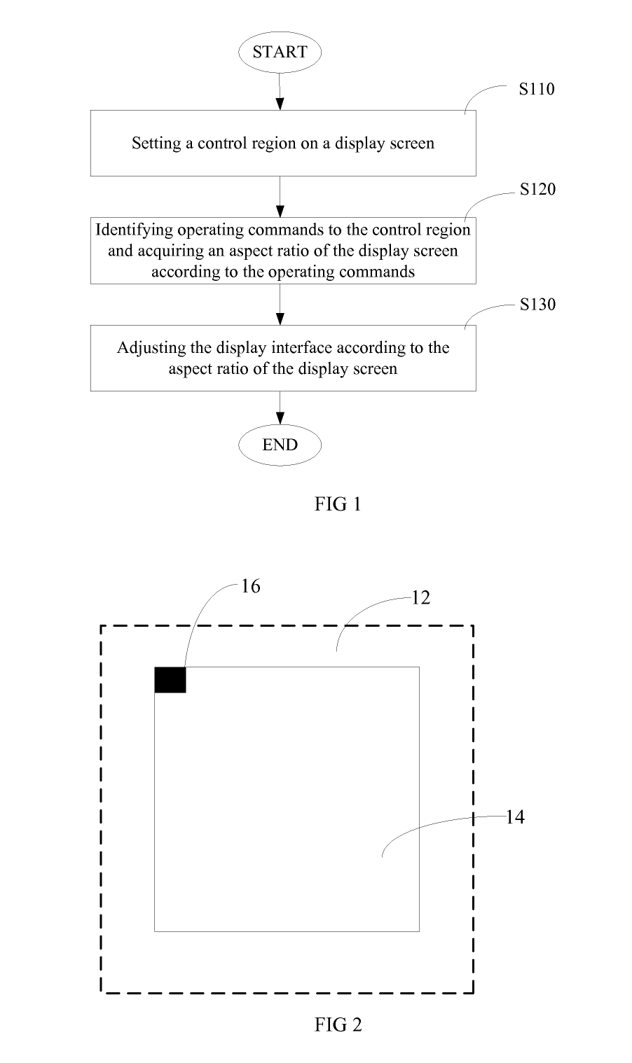

In an embodiment, the operating commands are identified. Referring to FIG. 2, firstly, the control region 16 on the display interface 12 is double clicked which functions as providing a double click command as the first click command mentioned above, and then the double click command is received and identified and the aspect ratio of the display screen 14 is acquired according to the double click command. For example, the display screen 14 has a 4:3 aspect ratio according to FIG. 2.

In step S130, the display interface is adjusted according to the aspect ratio of the display screen.

In an embodiment, referring to FIG. 2, the original display interface 12 is beyond the display range of the display screen 14. The aspect ratio of the display screen 14 is acquired by operating on the control region 16 and the aspect ratio of the display interface 12 is adjusted according to the aspect ratio of the display screen 14. In a preferred embodiment, the best matched aspect ratio of the display interface 12 is acquired by adjusting the display interface 12 according to the aspect ratio of the display screen 14. By operating on the control region 16, the aspect ratio of the display interface 12 can be quickly adjusted to match the display screen 14.

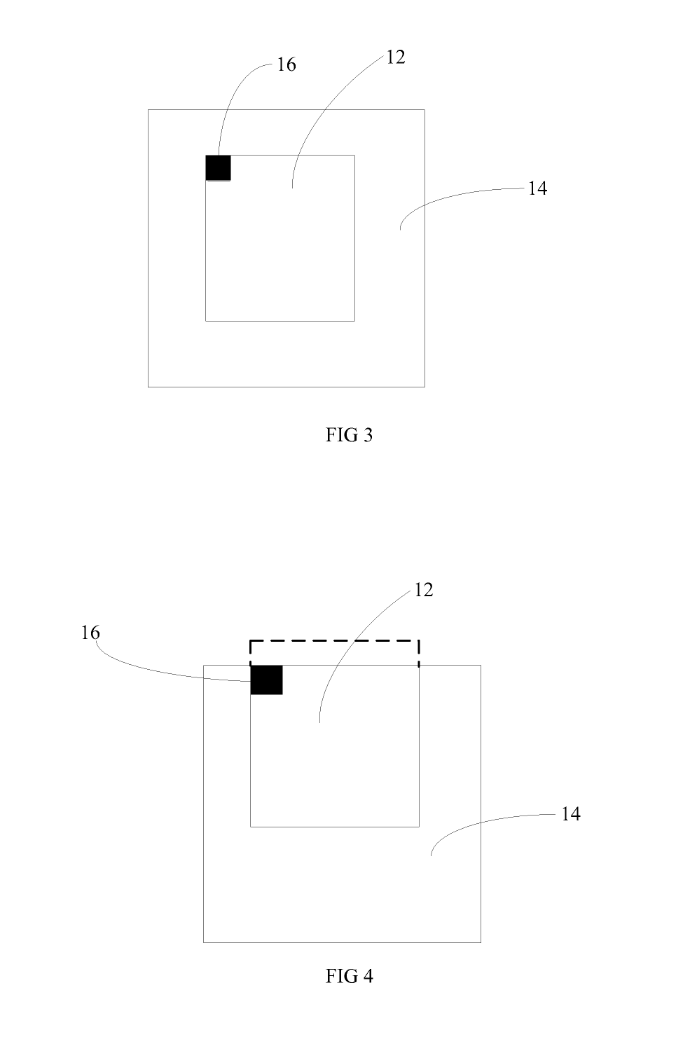

In another embodiment, the original display interface 12 shown in FIG. 3 is smaller than the display range of the display screen 14. The principle of the adjusting is similar to that of the method of aforementioned embodiment. Furthermore, in this embodiment, user can choose to fine adjust the display interface 12 or to adjust the display interface 12 by a scaling operation using some predetermined percentages, such as amplifying the original display interface 12 by 5% or 10% one time.

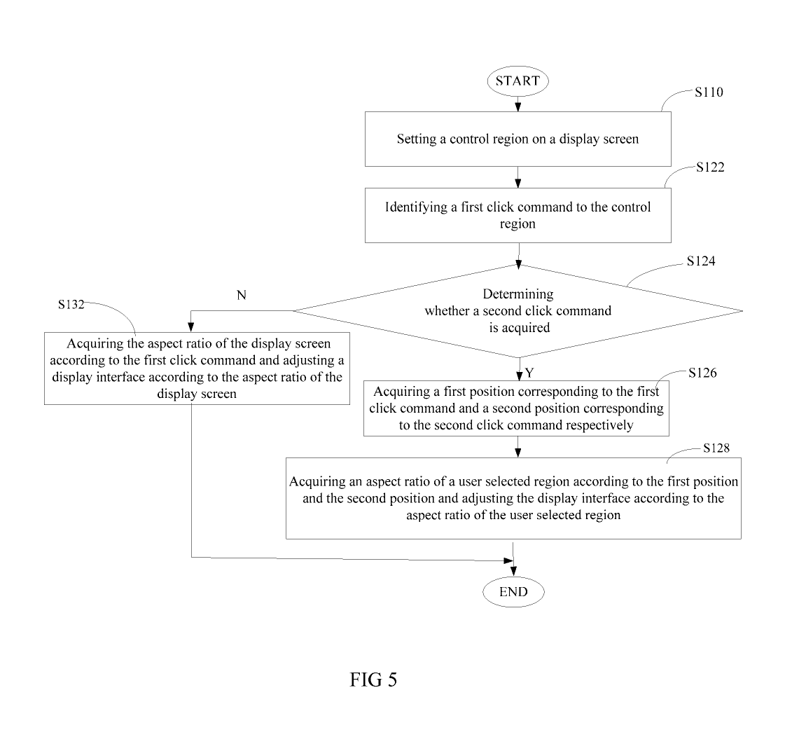

Or as another situation shown in FIG. 4, the original display interface 12 is partly displayed on the display screen 14. The principle of the adjusting is similar to those of aforementioned embodiments, and herein need not repeat again.

According to FIGS. 2-4, the aspect ratio of the display screen 14 is acquired by operating on the control region 16 and the aspect ratio of the display interface 12 is adjusted according to the aspect ratio of the display screen 14. Preferably, the center of the display interface 12 coincides with that of the display screen 14.

Referring to FIG. 5, a method for adjusting the display interface in accordance with another embodiment includes following steps.

In step S110, a control region is set on a display screen.

In step S122, a first click command for the control region is received and identified.

In step S124, a determination is made as to whether a second click command is received. If the second click command is received, step 126 is executed, otherwise step 132 is executed.

In step S126, a first position corresponding to the first click command and a second position corresponding to the second click command are acquired respectively.

In step S128, An aspect ratio of a user selected region is acquired according to the first position and the second position and the display interface is adjusted according to the aspect ratio of the user selected region.

In step S132, the aspect ratio of the display screen is acquired according to the first click command and the display interface is adjusted according to the aspect ratio of the display screen.

In an embodiment, the step S128 “the aspect ratio of the user selected region is acquired according to the first position and the second position” specifically includes: acquiring a first coordinate corresponding to the first position; acquiring a second coordinate corresponding to the second position; identifying the user selected region according to the first coordinate and the second coordinate; acquiring the aspect ratio of the user selected region according to the aspect ratio of the user selected region.

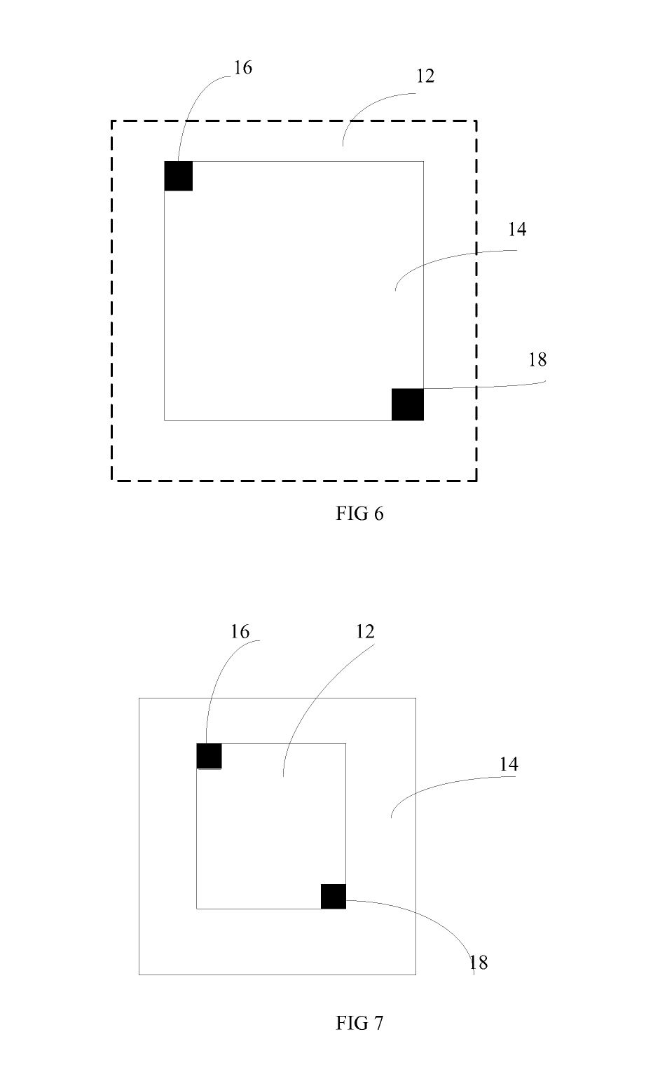

In an embodiment, according to FIG. 6, the first position 16 is clicked and then the second position 18 on the display screen 14 is also clicked by a user, the coordinates of the first position 16 and the second position 18 are acquired respectively. The user selected region can be identified according to the coordinates of the first position 16 and the second position 18 and then the aspect ratio of the user selected region is thus acquired. Preferably, the user selected region may always be the display interface 12. In this embodiment of FIG. 6, the original display interface 12 is larger than the display range of the display screen 14. By clicking the first position 16 and the second position 18, the aspect ratio of the user selected region is acquired, so as to adjust the display interface 12 to match the display screen 14.

In another embodiment, referring to FIG. 7, the original display interface 12 is smaller than the display range of the display screen 14. In view of aforementioned embodiment, by clicking the first position 16 and the second position 18 on the display screen 14, the aspect ratio of the user selected region is acquired to adjust the display interface 12 to match the display screen 14. In this embodiment, during the process of adjusting the display interface 12, user can choose to finely adjust the display interface 12 or to adjust the display interface 12 by a scaling operation using some predetermined percentages, such as amplifying the original display interface 12 by 5% or 10% one time, to make the display interface 12 match the display screen 14.

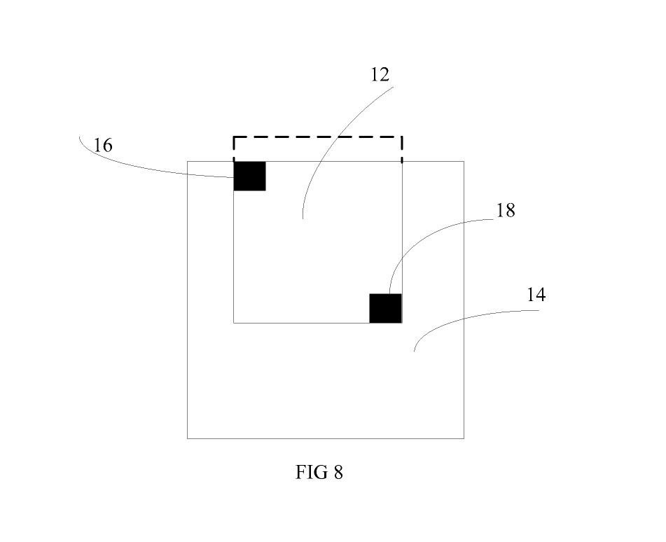

In another embodiment, referring to FIG. 8, the display interface 12 is partly displayed on the display screen 14. In view of the aforementioned embodiments, the principle of the adjusting method is similar to that of the aforementioned method, and herein need not repeat again.

Referring to FIGS. 6-8, the display interface 12 can be adjusted according to the aspect ratio of the user selected region. Preferably, the center of the display interface 12 can be adjusted to coincide with that of the display screen 14.

Referring to FIG. 9, in an embodiment, a system for adjusting the display interface includes a setting module 10, an information acquiring module 20, and an interface adjusting module 30.

The setting module 10 is used for setting a control region on a display screen.

In another embodiment, the setting module 10 is further used for setting the control region at arbitrary positions of the display screen.

The information acquiring module 20 is used for identifying the operating commands to the control region and acquiring an aspect ratio of the display screen according to the operating commands.

In an embodiment, the information acquiring module 20 is further used for acquiring a display location of the display interface displayed on the display screen, and the control region will be displayed on the display interface by the setting module 10 according to said display location. In this embodiment, the information acquiring module 20 is also used for identifying a first click command to the control region and then acquiring the aspect ratio of the display screen according to the first click command.

The interface adjusting module 30 is used for adjusting the display interface according to the aspect ratio of the display screen.

Referring to FIG. 2, the control region 16 is set on the display screen 14 by the setting module 10. After the information acquiring module 20 identifies the operating commands to the control region 16, it will acquire the aspect ratio of the display screen 14 according to the operating commands. The interface adjusting module 30 adjusts the display interface 12 according to the aspect ratio of the display screen 14. Preferably, the interface adjusting module 30 adjusts the display screen to have a best matched aspect ratio with the display interface 12. In this embodiment, the original display interface 12 is larger than the display range of the display screen 14. After the information acquiring module 20 acquires the operating commands to the control region 16, the display interface 12 will be adjusted according to the operating commands. Therefore the aspect ratio of the display interface 12 can be quickly adjusted to match the display screen 14.

In another embodiment as shown in FIG. 3, the original display interface 12 is smaller than the display range of the display screen 14, and its principle of the adjusting method is similar to that of the adjusting method of aforementioned embodiment. However, in this embodiment, during the process of the interface adjusting module 30 adjusting the display interface 12, the user can choose to fine adjust the display interface 12 or to adjust the display interface 12 by a scaling operation using some predetermined percentages, such as amplifying the original display interface 12 by 5% or 10% one time in this embodiment.

In another embodiment as shown in FIG. 4, only a part of the original display interface 12 is shown on the display screen 14. The principle of the adjusting method is the same as that of the aforementioned embodiments with any more depiction.

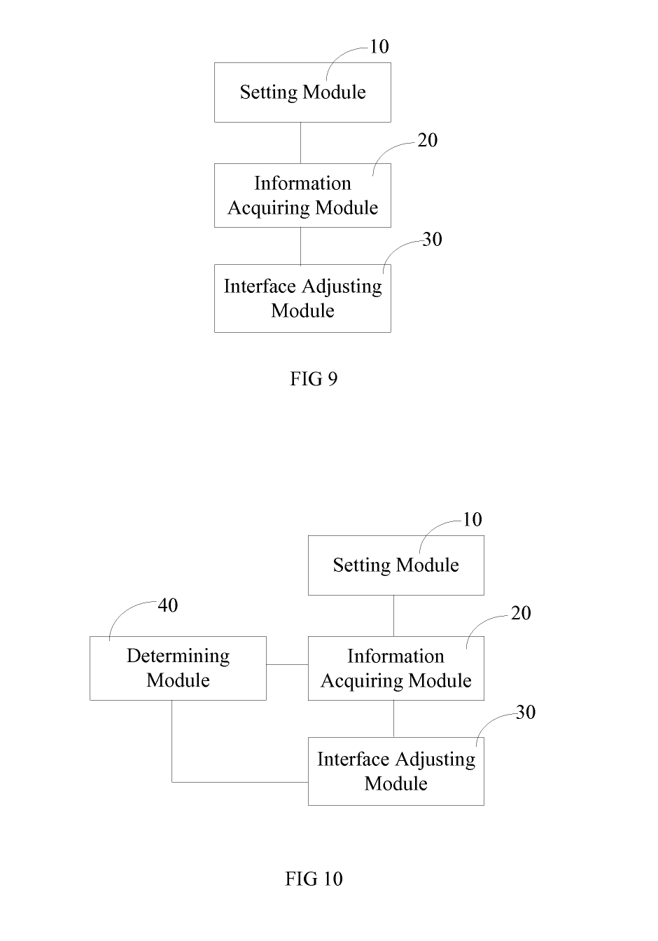

Another embodiment is shown in FIG. 10, a system for adjusting the display interface includes the setting module 10, the information acquiring module 20, the interface adjusting module 30 and a determining module 40.

The determining module 40 is used for determining whether a second click command is acquired after the information acquiring module 20 identifying the first click command to the control region; If the information acquiring module 20 acquires a first position corresponding to the first click command and a second position corresponding to the second click command respectively, and acquires an aspect ratio of the user selected region according to the first position and the second position, then the interface adjusting module 30 adjusts the display interface according to the aspect ratio of the user selected region.

In an embodiment as illustrated in FIG. 6, the information acquiring module 20 acquires the coordinates of the first position 16 and the second position 18 on the display screen 14 respectively, then identifies the user selected region according to the coordinates of the two positions 16 and 18 and thus acquires the aspect ratio of the user selected region. The user selected region is generally preferred to be the display interface 12. In this embodiment, the size of the display interface 12 is larger than the display range of the display screen. The interface adjusting module 30 adjusts the display interface 12 to match the display screen 14 according to the aspect ratio of the user selected region which is acquired according to the acquired first position and the second position.

As shown in FIG. 7, in another embodiment, the size of the display interface 12 is smaller than the display range of the display screen 14 originally, the adjusting method is similar to the method set forth above. However, in this embodiment, the user can choose to finely adjust the display interface 12 or to adjust the display interface 12 by a scaling operation using some predetermined percentages, such as amplifying the original display interface 12 by 5% or 10% one time.

In another embodiment as shown in FIG. 8, only a part of the display interface 12 is displayed on the display screen 14. In view of aforementioned embodiments, the principle of the adjusting method is similar to that of the aforementioned embodiments without more depiction.

The above mentioned display interface adjusting method and system set a control region on a display screen; identify the operating commands to the control region and acquire the aspect ratio of the display screen according to the operating commands; and then adjust the display interface according to the aspect ratio of the display screen. Since the aspect ratio of the display interface can be quickly adjusted just by the control region of the display screen, it is more flexible and time-effective to adjust the display interface to have a best matched aspect ratio with the display screen.

It is understood that the disclosed embodiments may be used to any appropriate semiconductor device manufacturing processes. Various alternations, modifications, or equivalents to the technical solutions of the disclosed embodiments can be obvious to those skilled in the art.

What is claimed is:

1. A display interface adjusting method for a display screen, comprising:
setting a control region on the display screen;
identifying operating commands to the control region and acquiring an aspect ratio of the display screen according to the operating commands; and
adjusting the display interface according to the aspect ratio of the display screen.

2. The display interface adjusting method according to claim 1, wherein the step of setting said control region on the display screen comprises: said control region can be set at arbitrary positions of the display screen.

3. The display interface adjusting method according to claim 1, wherein the step of setting said control region on the display screen comprises: acquiring a display location of the display interface displayed on the display screen; and displaying the control region on the display interface according to the display location.

4. The display interface adjusting method according to claim 1, wherein the step of identifying the operating commands to the control region comprises: identifying a first click command to the control region; and
the step of adjusting the display interface according to the aspect ratio of the display screen includes acquiring the aspect ratio of the display screen according to the first click command and adjusting the display interface according to the aspect ratio of the display screen.

5. The display interface adjusting method according to claim 4, wherein the step of identifying the operating commands to the control region further comprises: determining whether a second click command is acquired, and if the second click command is acquired, then a first position corresponding to the first click command and a second position corresponding to the second click command will be acquired respectively;
acquiring an aspect ratio of a user selected region according to the first position and the second position; and
adjusting the display interface according to the aspect ratio of the user selected region.

6. A display interface adjusting system for a display screen, comprising:
a setting module used for setting a control region on the display screen;
an information acquiring module used for identifying operating commands to the control region and for acquiring an aspect ratio of the display screen according to the operating commands;
and an interface adjusting module used for adjusting a display interface according to the aspect ratio of said display screen.

7. The display interface adjusting system according to claim 6, wherein said setting module is further used for setting said control region on arbitrary positions of the display screen.

8. The display interface adjusting system according to claim 6, wherein the information acquiring module is further used for acquiring a display location of the display interface displayed on the display screen; and
the setting module is further used for displaying the control region on the display interface according to the display location.

9. The display interface adjusting system according to claim 6, wherein the information acquiring module is further used for identifying a first click command to the control region and acquiring an aspect ratio of the display screen according to the first click command.

10. The display interface adjusting system according to claim 9, wherein the system further comprises a determining module used for determining whether a second click command is acquired after the first click command to the control region is acquired by said information acquiring module;
and if the information acquiring module acquires the second click command, the information acquiring module will acquire a first position and a second position according to the first click command and the second click command respectively, and then further acquire an aspect ratio of a user selected region according to the first position and the second position;
the display interface is adjusted by said interface adjusting module according to the aspect ratio of the user selected region.
